(19) United States
(12) Patent Application Publication
(10) Pub. No.: US 2021/0138312 A1
(43) Pub. Date: May 13, 2021

(54) METHOD FOR MANUFACTURING A HITTING PANEL FOR GOLF CLUB HEAD

(71) Applicant: Chi-Shun CHUANG, TAICHUNG CITY (TW)

(72) Inventor: Chi-Shun CHUANG, TAICHUNG CITY (TW)

(21) Appl. No.: 16/704,450

(22) Filed: Dec. 5, 2019

(30) Foreign Application Priority Data
Nov. 7, 2019 (TW) 108140450

(51) Int. Cl. A63B 53/04

(52) U.S. Cl. CPC A63B 53/04; A63B 2053/0416

(57) ABSTRACT

A method for manufacturing a hitting panel with precise dimensions and high quality for golf club head is disclosed to include the steps of material preparing and cutting, primary hot pressing, planar milling, secondary hot pressing, third hot pressing, cold pressing and hitting surface formation.

### BACKGROUND OF THE INVENTION

### 1. Field of the Invention

The present invention relates to golf club technology, and more particularly, to a method for manufacturing a hitting panel for golf club head.

### 2. Description of the Related Art

Traditionally, the hitting panels for golf club are made of metal materials. Whether maraging steel or titanium alloy is used, the main practice on the market today is to manufacture hitting panels by stamping and cutting. That is to say, the metal sheet to be formed is pressed out in the desired form by stamping, and then a milling cutter is used to cut the required thickness and shape. Although this method is fast and simple, but because the hitting panel is only subjected to high temperature extrusion once, there is still a lot of instability in the material itself. Especially in the subsequent need to bend into a cup-shaped hitting panel, this potential problem will be more obvious, and the accuracy of the angle and size of the bend will become more difficult to control.

### SUMMARY OF THE INVENTION

The present invention has been accomplished under the circumstances in view. It is the main object of the present invention to provide a method for manufacturing a hitting panel for golf club head, which can improve the accuracy of the size of the hitting panel.

To achieve this and other objects of the present invention, a method for manufacturing a hitting panel for golf club head comprises the steps of material preparing and cutting, primary hot pressing, planar milling, secondary hot pressing, third hot pressing, cold pressing and hitting surface formation. The hitting panel made using this method has the characteristic of precise dimensions and high quality.

### BRIEF DESCRIPTION OF THE DRAWINGS

FIG. 1 is a schematic view of Step A of the method for manufacturing a hitting panel for golf club head in accordance with the present invention.

FIG. 2 is a schematic view of Step B of the method for manufacturing a hitting panel for golf club head in accordance with the present invention (I).

FIG. 3 is a schematic view of Step B of the method for manufacturing a hitting panel for golf club head in accordance with the present invention (II).

FIG. 4 is a schematic view of Step C of the method for manufacturing a hitting panel for golf club head in accordance with the present invention (I).

FIG. 5 is a schematic view of Step C of the method for manufacturing a hitting panel for golf club head in accordance with the present invention (II).

FIG. 6 is a schematic view of Step E of the method for manufacturing a hitting panel for golf club head in accordance with the present invention (I).

FIG. 7 is a flow chart of the method for manufacturing a hitting panel for golf club head in accordance with the present invention.

### DETAILED DESCRIPTION OF THE INVENTION

Referring to FIGS. 1-7, a method for manufacturing a hitting panel for golf club head in accordance with the present invention comprises the steps as follows:

Step A, material preparing and cutting, which is to select a metal sheet 1 for processing into a hitting panel and to cut out the shape of the desired hitting panel 10 from the selected metal sheet, as shown in FIG. 1. The cutting method can be implemented by milling or stamping or laser cutting. In this embodiment, the metal sheet used for stamping is a maraging steel sheet.

Step B, primary hot pressing, which is to place the cut metal sheet into a mold and to heat the mold to about 810° C. (810±30° C.), and then to mold out the concave and convex shape required for the hitting panel under a pressure of 100 Kg for a duration of 5-6 seconds. In particular, the cutting portion 11 whose thickness is to be reduced is pressed toward the same side, as shown in FIGS. 2 and 3. In this embodiment, the temperature of the hot pressing will change according to the material to be molded, and is not limited to 810° C. but usually means that the processing temperature exceeds 100° C.

Step C, planar milling, which is to take out the metal sheet processed in Step B from the mold and to place the metal sheet on a milling machine, and then to flat one side 12 of the metal sheet by milling with a milling cutter, as shown in FIG. 4 and FIG. 5. The planar milled surface will become the hitting surface of the hitting panel.

Step D, secondary hot pressing, which is to place the metal sheet processed in Step C in a mold and to heat the mold to about 810° C. (810±30° C.), and then to mold out the curvature required for the hitting panel under a pressure of 100 Kg for a duration of 3-4 seconds. This hot pressing action is to pre-form the hitting surface.

Step E, third hot pressing, which is to place the metal sheet processed in Step D in a mold and to heat the mold to about 810° C. (810±30° C.), and then to mold out the curvature required for the hitting panel under a pressure of 100 Kg for a duration of 5-6 seconds, as shown in FIG. 6. The difference between this Step E and the previous Step D is that the previous Step D is preforming, and this Step E is molding. It is necessary to divide the forming action into two actions of preforming and forming, the purpose of which is to prevent the material from being deformed too much and being burst or broken during molding.

Step F, cold pressing, which is to place the metal sheet processed in Step E into a mold and to cool the mold to about 25° C. (25±5° C.), and then to mold out the curvature required for the hitting panel under a pressure of 100 Kg for a duration of 3-4 seconds. Through this cold pressing process, the shape and size of the metal sheet are more stable, so as to reduce the springback or deformation of the metal sheet during hot pressing, thus, the size and shape of the finished product can be more precise. The cold pressing referred to in the present preferred embodiment means that the temperature of the workpiece during processing is lower than 50° C., preferably at room temperature (25° C.) or below.

Step G, hitting surface formation, which is to place the metal sheet processed in Step F on the milling machine and then to mill the plane and height of the hitting surface of the metal sheet according to the structural diagram of the hitting surface.

Through the above processing procedure, the invention can make a hitting panel with precise dimensions and high quality without complicated processing equipment and procedures.

What is claimed is:

1. A method for manufacturing a hitting panel for golf club head, comprising the steps of:
Step A) material preparing and cutting, which is to select a metal sheet for processing into a hitting panel and to cut out the shape of the desired hitting panel from said metal sheet;
Step B) primary hot pressing, which is to place said cut metal sheet into a mold to be heated and pressurized, and then to mold out a concave and convex shape required for the hitting panel;
Step C) planar milling, which is to take out said cut metal sheet processed in Step B from the mold and to place said cut metal sheet on a milling machine, and then to flat one side of said cut metal sheet by milling with a milling cutter;
Step D) secondary hot pressing, which is to place said cut metal sheet processed in Step C in a mold and to heat and pressurize the mold for molding out the curvature required for the hitting panel;
Step E) third hot pressing, which is to place said cut metal sheet processed in Step D in a mold and to heat and pressurize the mold for molding out the curvature required for the hitting panel;
Step F) cold pressing, which is to place said cut metal sheet processed in Step E into a mold and to cool and pressurize the mold for molding out the curvature required for the hitting panel; and
Step G) hitting surface formation, which is to place said cut metal sheet processed in Step F on the milling machine and then to mill the plane and height of the hitting surface of said cut metal sheet according to the structural diagram of the hitting surface.

2. The method for manufacturing a hitting panel for golf club head as claimed in claim 1, wherein is Step B), the mold is heated to about 810° C. (810±30° C.) and then pressurized to a pressure of 100 Kg for a duration of 5-6 seconds.

3. The method for manufacturing a hitting panel for golf club head as claimed in claim 1, wherein is Step D), the mold is heated to about 810° C. (810±30° C.) and then pressurized to a pressure of 100 Kg for a duration of 3-4 seconds.

4. The method for manufacturing a hitting panel for golf club head as claimed in claim 1, wherein is Step E), the mold is heated to about 810° C. (810±30° C.) and then pressurized to a pressure of 100 Kg for a duration of 5-6 seconds.

5. The method for manufacturing a hitting panel for golf club head as claimed in claim 1, wherein in Step F), said cut metal sheet processed in Step E is placed into the mold and the mold is then cooled down to about 25° C. (25±5° C.), and then the mold is pressurized to a pressure of 100 Kg for a duration of 3-4 seconds to mold out the curvature required for the hitting panel.
